(19) United States
(12) Patent Application Publication
(10) Pub. No.: US 2007/0059443 A1
(43) Pub. Date: Mar. 15, 2007

(54) MASK FORMING METHOD AND INFORMATION RECORDING MEDIUM MANUFACTURING METHOD

(75) Inventors: Akimasa KAIZU, Tokyo (JP); Kazuharu OHBA, Tokyo (JP); Minoru FUJITA, Tokyo (JP); Mitsuru TAKAI, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/468,445

(22) Filed: Aug. 30, 2006

(30) Foreign Application Priority Data
Sep. 7, 2005 (JP) 2005/259157

(51) Int. Cl. B29D 17/00

(52) U.S. Cl. 427/162; 264/1.36; 264/1.33

(57) ABSTRACT

A mask forming method forms a concave/convex pattern in a mask when the mask is formed over a substrate. A coating film forming process forms a coating film by applying a radiation-curing coating composition onto the substrate. A radiation irradiating process then irradiates the coating film with radiation. Finally, a pattern transferring process presses a surface of a stamper on which a concave/convex pattern has been formed onto the coating film to transfer the concave/convex pattern to the coating film.

### BACKGROUND OF THE INVENTION

1. Field of the Invention

The present invention relates to a mask forming method that forms a mask by transferring a concave/convex pattern of a stamper to a coating film that has been applied onto a substrate, and to an information recording medium manufacturing method that manufactures an information recording medium using a mask formed according to the mask forming method.

2. Description of the Related Art

As one example of this type of mask forming method, a mask forming method that forms a mask pattern used when etching a thin film formed on a substrate is disclosed by Japanese Laid-Open Patent Publication No. H05-80530. In this mask forming method, first an organic resin layer is formed by applying an organic light-curing resin so as to cover the thin film formed on the substrate. Next, the surface of a stamper, which has been formed of a light-transmitting material such as polycarbonate, polymethyl methacrylate, or glass, on which a concave/convex pattern has been formed is pressed onto the organic resin layer. After this, the organic resin layer on the thin film is irradiated with light transmitted through the stamper to harden the organic resin layer. Next, the stamper is separated from the hardened organic layer. By doing so, a mask pattern (or simply “mask”) is formed on the thin film composed of the organic resin layer. After this, the thin film is etched using the formed mask pattern. By doing so, the thin film is removed from the substrate at the positions of the concaves in the mask pattern, thereby forming a thin-film pattern on the substrate.

### SUMMARY OF THE INVENTION

By investigating the conventional mask forming method described above, the present inventors found the following problem. With the conventional mask forming method, a stamper formed of a material that transmits light is used so that during the hardening process, the organic resin layer can be irradiated with light that passes through the stamper. When the stamper is formed of a resin material such as polycarbonate or polymethyl methacrylate, it is difficult to sufficiently increase the durability of the stamper, which makes it difficult to repeatedly use the stamper and increases the cost of forming the mask. Also, when the stamper is formed of glass, whenever a single stamper is manufactured, it is necessary to carry out a process that forms a concave/convex pattern on the glass plate used to form the stamper. This also increases the cost of manufacturing the stamper, resulting in an increase in the cost of forming the mask. In this way, with the conventional mask forming method, there is the problem that using a light-transmitting stamper causes an increase in the cost of forming a mask.

The present invention was conceived in view of the problem described above and it is a principal object of the present invention to provide a mask forming method that can reduce the cost of forming a mask and an information recording medium manufacturing method that can reduce the cost of manufacturing an information recording medium.

A mask forming method according to the present invention forms a concave/convex pattern in a mask formed over a substrate, the mask forming method comprising: a coating film forming process that forms a coating film by applying a radiation-curing coating composition onto the substrate; a radiation irradiating process that irradiates the coating film with radiation; and a pattern transferring process that presses a surface of a stamper on which a concave/convex pattern has been formed onto the coating film to transfer the concave/convex pattern to the coating film, wherein the coating film forming process, the radiation irradiating process, and the pattern transferring process are carried out in the mentioned order.

With the mask forming method according to the present invention, a coating film forming process that forms a coating film by applying a radiation-curable coating composition onto the substrate, a radiation irradiating process that irradiates the coating film with radiation, and a pattern transferring process that transfers the concave/convex pattern of the stamper to the coating film are carried out in the mentioned order to form a concave/convex pattern of a mask. By doing so, unlike the conventional mask forming method that forms a mask by hardening an organic resin layer by irradiation with light transmitted through a stamper, it is possible to form the mask without using a stamper formed of a light-transmitting material. Since it is possible to manufacture the stamper using a variety of materials selected in view of their durability, for example, it becomes possible to repeatedly use the stamper, and as a result the cost of forming the mask can be sufficiently reduced. Also, unlike when the stamper is formed of glass, for example, it is possible to easily fabricate a plurality of metal stampers from a single stamper manufacturing matrix, and therefore the manufacturing cost of the stamper can be sufficiently reduced.

The mask forming method according to the present invention may apply, as the coating composition, a resin material where a hardening reaction proceeds even after irradiation with the radiation has stopped. By doing so, by irradiating the coating film with radiation before the pattern transferring process is carried out, the hardening reaction of the coating film will gradually proceed from the commencement of irradiation with the radiation and the coating film will gradually harden even during the pattern transferring process (i.e., while the stamper is being pressed onto the coating film). As a result, a situation where the pattern loses its shape when the pattern transferring process is completed (i.e., when the stamper is separated from the coating film) is avoided, and the concave/convex pattern can be properly transferred across the entire substrate. Also, by suitably adjusting the irradiated amount of radiation on the coating film (i.e., the irradiation intensity and the irradiating time of the radiation), it is possible to sufficiently harden the coating film without irradiating the coating film after the pattern transferring process has been completed (i.e., after the stamper has been separated from the coating film). Accordingly, compared to a pattern forming method where the coating film is irradiated with radiation before and after the pattern transferring process, the time required to form the mask can be sufficiently reduced and therefore the forming cost can be sufficiently reduced.

When doing so, as one example, a resin material where a hardening reaction proceeds due to cationic polymerization may be applied as the resin material.

An information recording medium manufacturing method according to the present invention manufactures an information recording medium using a mask formed using the mask forming method described above. More specifically, for example, the information recording medium is manufactured by forming a concave/convex pattern on the substrate using a mask formed using the above mask forming method. In this case, “forming a concave/convex pattern on a substrate” for the present invention includes both processes that form the concave/convex pattern by forming concaves in the substrate and processes that form the concave/convex pattern by forming convexes on the substrate. Note that the information recording medium manufacturing method using a mask is not limited to the method where the information recording medium is manufactured by forming the concave/convex pattern on the substrate using the mask, but includes a method where the information recording medium is manufactured by partially altering properties of the surface of the substrate (i.e., the surface of the magnetic layer and the like) using the mask. By manufacturing an information recording medium using the mask described above, it is possible to sufficiently reduce the manufacturing cost of the information recording medium.

It should be noted that the disclosure of the present invention relates to a content of Japanese Patent Application 2005-259157 that was filed on 7 Sep. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of an information recording medium manufacturing apparatus;

FIG. 2 is a cross-sectional view of an information recording medium;

FIG. 3 is a cross-sectional view of a stamper;

FIG. 4 is a cross-sectional view of a preform in a state where a coating film has been formed;

FIG. 5 is a cross-sectional view of the preform in a state where a concave/convex pattern of the stamper has been pressed onto the coating film;

FIG. 6 is a cross-sectional view of the preform in a state where a concave/convex pattern (a mask) has been formed by separating the stamper;

FIG. 7 is a diagram useful in explaining the relationship between the irradiation intensity of UV rays and the form of the concave/convex pattern; and

FIG. 8 is a diagram useful in explaining the relationship between the time from the stopping of irradiation to the pressing of the stamper onto the coating film and the form of the concave/convex pattern.

### DESCRIPTION OF THE PREFERRED EMBODIMENTS

Preferred embodiments of a mask forming method and an information recording medium manufacturing method according to the present invention will now be described with reference to the attached drawings.

First, the construction of an information recording medium manufacturing apparatus 50 (hereinafter also referred to as the “manufacturing apparatus 50”) that manufactures an information recording medium by forming a mask in accordance with the mask forming method according to the present invention will be described with reference to the drawings.

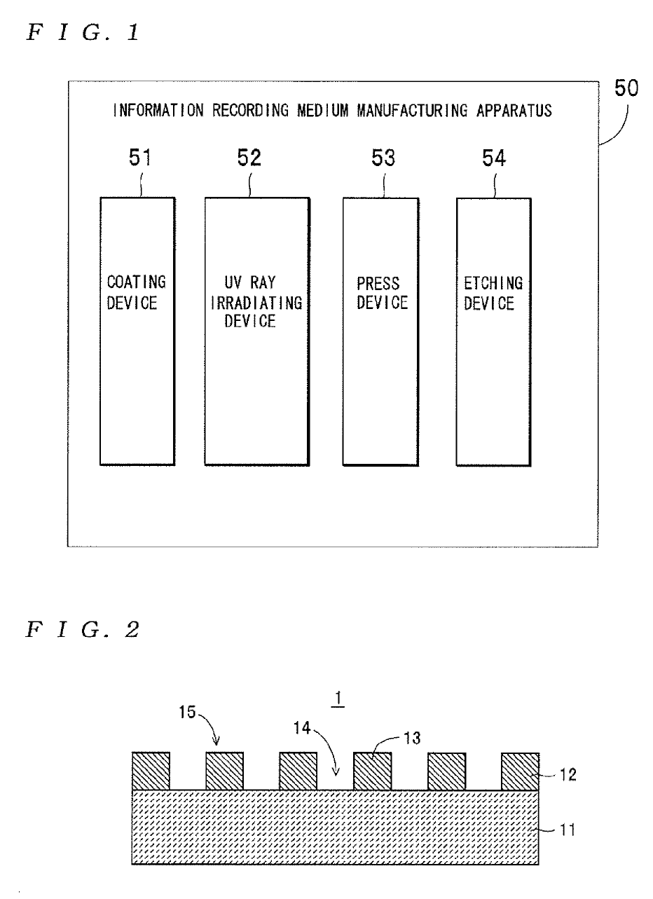

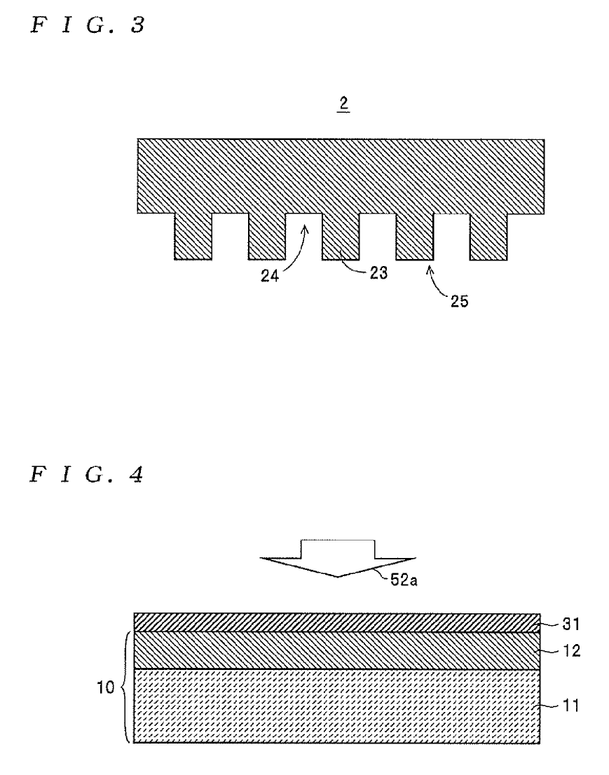

The manufacturing apparatus 50 shown in FIG. 1 includes a coating device 51, a UV ray irradiating device 52, a press device 53, and an etching device 54, forms a mask 30 (see FIG. 6) in accordance with the mask forming method according to the present invention, and manufactures an information recording medium 1 shown in FIG. 2 by carrying out an etching process that uses the mask 30. When doing so, the manufacturing apparatus 50 forms the mask 30 using a preform 10 (see FIG. 4) used to manufacture an information recording medium and a stamper 2 (see FIG. 3). The preform 10 corresponds to a “substrate” for the present invention and as shown in FIG. 4, includes a circular-plate shaped base plate 11 with a diameter of around 2.5 inches and a magnetic layer 12 formed on the base plate 11. Note that in FIG. 4, a state where a coating film 31 has been formed on the preform 10 is shown. Although various functional layers such as a soft magnetic layer and an oriented layer are formed between the base plate 11 and the magnetic layer 12, for ease of understanding the present invention, such layers have been omitted from the drawings and the description. The stamper 2 is a matrix for forming the mask 30 on the preform 10, and is formed in an overall circular-plate shape using for example a metal material (such as nickel) Also, as shown in FIG. 3, a concave/convex pattern 25 including a plurality of convexes 23 and a plurality of concaves 24 is formed on one surface (the surface on which the concave/convex pattern is formed for the present invention: the lower surface in FIG. 3) of the stamper 2. Note that there are no particular limitations on the material or manufacturing method for forming the stamper 2 and it is possible to manufacture the stamper 2 in accordance with a variety of well-known manufacturing methods using well-known materials.

As one example, the information recording medium 1 is a discrete-track type magnetic recording medium (patterned medium), and constructs a magnetic recording apparatus (i.e., a hard disk drive) by being enclosed inside a case together with a motor for rotating the information recording medium 1, a recording/reproducing head for recording and reproducing data onto and from the information recording medium 1 (i.e., a flying head slider on which a recording head and a reproducing head are formed), and the like. As shown in FIG. 2, the information recording medium 1 has data track patterns, servo patterns, and the like (collectively referred to as the “concave/convex patterns 15”) formed by a plurality of convexes 13 and a plurality of concaves 14 formed in the magnetic layer 12 and is constructed so that data can be recorded by a perpendicular recording method. Here, on the information recording medium 1, the convexes 13 are formed corresponding to the concaves 24 in the concave/convex pattern 25 of the stamper 2 and the concaves 14 are formed corresponding to the convexes 23 in the concave/convex pattern 25. Note that in FIGS. 2 to 6 referred to by the present specification, for ease of understanding the present invention, the thicknesses of the respective layers are shown differently to the actual thicknesses and the widths of the convexes and the concaves in the concave/convex patterns are shown differently to the actual widths.

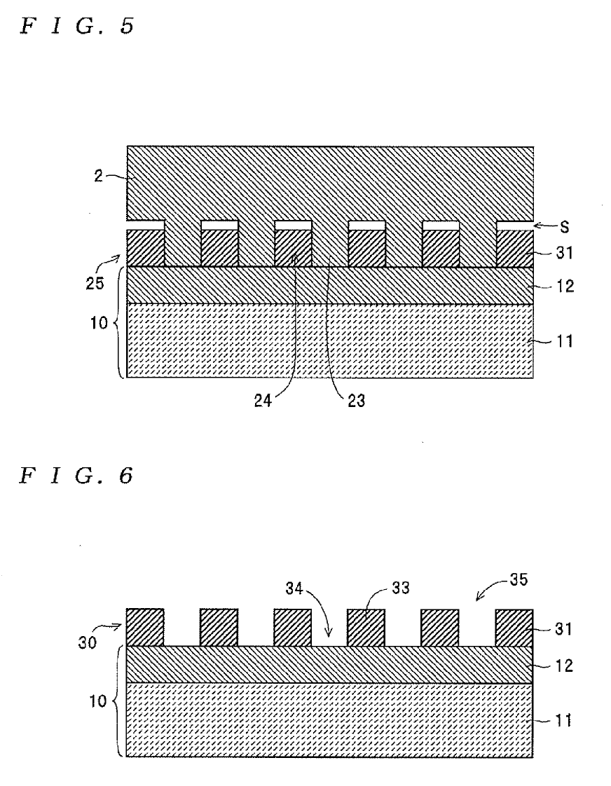

The coating device 51 carries out a “coating film forming process” for the present invention, and spin coats a UV-curing resin material as a “radiation-curing coating composition” for the present invention onto the magnetic layer 12 of the preform 10 as shown in FIG. 4 to form the coating film 31 on the preform 10. Here, as the resin material, as described later it is preferable to use a resin material where a hardening reaction commences when the material is irradiated with UV rays 52a and the hardening reaction proceeds even after irradiation with the UV rays 52a has stopped. As a specific example, it is preferable to use a resin material where a hardening reaction due to cationic polymerization commences when the material is irradiated with the UV rays 52a. Note that since cationic polymerization is well known, detailed description thereof is omitted. The UV ray irradiating device 52 carries out a “radiation irradiating process” for the present invention, and irradiates the coating film 31 on the preform 10 with the UV rays 52a as one example of “radiation” for the present invention. The press device 53 carries out a “pattern transferring process” for the present invention and as shown in FIG. 5 presses the concave/convex pattern 25 of the stamper 2 onto the coating film 31 on the preform 10 to transfer the concave/convex pattern 25 to the coating film 31. The etching device 54 emits etching gas onto the preform 10 for which the formation of the mask 30 has been completed to remove (etch away) the magnetic layer 12 exposed from the mask 30, thereby forming the concaves 14 in the magnetic layer 12 to form the concave/convex patterns 15 on the base plate 11.

Next, the method of forming the mask 30 and the method of manufacturing the information recording medium 1 using the mask 30 will be described with reference to the drawings.

First, as shown in FIG. 4, the coating composition is spin coated (i.e., applied) onto the preform 10 by the coating device 51 to form the coating film 31 on the magnetic layer 12 (the “coating film forming process” for the present invention). When doing so, the coating device 51 spin coats an epoxy resin material where a hardening reaction proceeds due to cationic polymerization as the “coating composition” for the present invention. The coating film 31 formed on the preform 10 needs to be sufficiently thick to form convexes 33 (see FIG. 6) that are high enough to form the concaves 14 in the magnetic layer 12 during the etching process carried out by the etching device 54 (i.e., the coating film 31 needs to be sufficiently thick so that the mask 30 does not disappear before concaves 14 of a sufficient depth are formed). Accordingly, in this example where the mask 30 is formed for use when etching the magnetic layer 12, the coating film 31 should preferably be at least 50 nm thick. On the other hand, when the coating film 31 is excessively thick, thick residue will be produced between the convexes 23 of the stamper 2 and the magnetic layer 12 of the preform 10 during the pattern transferring process carried out by the press device 53 (i.e., the coating film 31 will remain between the convexes 23 and the magnetic layer 12). If thick residue is produced, a removing process carried out for the residue will take a long time. Accordingly, to form the residue sufficiently thinly to reduce the time required for removing the residue, the thickness of the coating film 31 should preferably be 200 nm or below. As one example, the thickness of the coating film 31 when the spin coating of the coating composition by the coating device 51 has been completed is 100 nm.

Next, the coating film 31 on the preform 10 is irradiated with the UV rays 52a by the UV ray irradiating device 52 (the “radiation irradiating process” for the present invention). When doing so, as one example the UV ray irradiating device 52 irradiates the coating film 31 for one second with 500 mW/cm² of UV rays 52a. As a result, a hardening reaction due to cationic polymerization commences for the coating composition (the coating film 31) applied onto the preform 10. Next, as shown in FIG. 5, the preform 10 on which the coating film 31 is formed is set in the press device 53 and the concave/convex pattern 25 of the stamper 2 is pressed onto the coating film 31 (the “pattern transferring process” for the present invention). When doing so, as one example, the press device 53 starts the pressing operation one minute after the stopping of irradiation with the UV rays 52a by the UV ray irradiating device 52 and holds the stamper 2 on the coating film 31 with a pressing force of 10 MPa. Within three minutes of the stopping of irradiation with the UV rays 52a, the coating film 31 will not have completely hardened and will remain in a sufficiently soft state. Accordingly, the convexes 23 in the concave/convex pattern 25 of the stamper 2 can be pressed sufficiently deeply into the coating film 31. As a result, it is possible to avoid having thick residue produced between the end surfaces of the convexes 23 in the concave/convex pattern 25 and the surface of the magnetic layer 12.

Next, the press device 53 keeps the stamper 9 pressed against the coating film 31 for three minutes. Since the hardening reaction due to cationic polymerization proceeds for the coating film 31 (the resin material) irradiated with the UV rays 52a by the UV ray irradiating device 52 even after irradiation with the UV rays 52a has stopped, the coating film 31 will gradually harden even when the stamper 2 is pressed against the coating film 31. Accordingly, the coating film 31 can sufficiently harden to a state where the transferred concave/convex pattern 35 does not lose its shape before the stamper 2 is separated. Next, the stamper 2 is separated from the coating film 31. By doing so, as shown in FIG. 6, the concave/convex pattern 25 of the stamper 2 is transferred to the coating film 31 to form the concave/convex pattern 35 (one example of the “concave/convex pattern of the mask” for the present invention), thereby forming the mask 30 on the preform 10. This completes the pattern transferring process for the present invention. Since the stamper 2 has sufficiently hardened by the time the stamper 2 is separated, it is possible to avoid a situation where the coating film 31 is separated from the preform 10 together with the stamper 2 and a situation where the concave/convex pattern 35 loses its shape due to unhardened parts being present when the stamper 2 is separated. Note that after the stamper 2 has been completely separated, the coating film 31 (the concave/convex pattern 35) may be further irradiated with the UV rays 52a for a predetermined time. When using this method, compared to a method where the coating film 31 is completely hardened by irradiation with the UV rays 52a before the stamper 2 is pressed onto the coating film 31, the coating film 31 can be completely hardened in a short time.

Next, the extremely thin residue (not shown) produced at the bottoms of the concaves 34 when the stamper 2 is separated is removed from the preform 10 by etching. Note that the expression “mask” for the present invention is not limited to the coating film 31 after the stamper 2 has been separated from the coating film 31 (i.e., the concave/convex pattern 35 in the state where residue is present), and also includes the coating film 31 after the residue produced at the bottoms of the concaves 34 has been completely removed (i.e., the concave/convex pattern 35 in a state where there is no residue). The removing process for the residue can also be carried out by the etching device 54. Next, the preform 10 for which the residue has been completely removed is set in the etching device 54 and the magnetic layer 12 is subjected to a dry etching process (one example of a process that “forms a concave/convex pattern on the substrate” for the present invention). More specifically, etching gas is emitted toward the surface of the preform 10 on which the mask 30 has been formed. When doing so, parts of the magnetic layer 12 exposed from the mask 30 (the magnetic layer 12 at the concaves 34) are removed to form the concaves 14 in the magnetic layer 12 corresponding to the concaves 34, so that as shown in FIG. 2, the concave/convex patterns 15 including the plurality of convexes 13 and the plurality of concaves 14 are formed on the base plate 11. By doing so, the information recording medium 1 is completed.

On the stamper 2 used in the mask forming method described above, the heights of the convexes 23 (or the depths of the concaves 24) in the concave/convex pattern 25 are set larger than the depths of the concaves 34 (or the heights of the convexes 33) in the concave/convex pattern 35 transferred to the coating film 31. More specifically, as shown in FIG. 5, the heights of the convexes 23 (or the depths of the concaves 24) are set so that in the state where the stamper 2 has been pressed onto the coating film 31 formed on the preform 10, gaps S are formed between the bottom surfaces of the concaves 24 and the surface of the coating film 31. On the other hand, with a stamper for forming an optical disc substrate, for example, the heights of the convexes (or the depths of the concaves) are set so that the base surfaces of the concaves in the concave/convex pattern and the end surfaces of the convexes transferred to the substrate molding material make surface contact (i.e., so that the gaps S described above are not formed). Accordingly, to form the convexes of the concave/convex pattern transferred to the optical disc substrate so as to coincide on the same plane, it is necessary to make the bottom surfaces of the concaves of the stamper coincide on the same plane. This makes it complex to manufacture the stamper for molding optical disc substrates, resulting in an increase in the manufacturing cost of optical discs.

On the other hand, on the stamper 2 for forming the mask, the bottom surfaces of the concaves 24 in the concave/convex pattern 25 do not need to coincide on the same plane, and therefore the concave/convex pattern 25 can be formed easily. As a result, increases in manufacturing cost can be avoided. In addition, with the stamper 2 where the heights of the convexes 23 (or the depths of the concaves 24) are set so that the gaps S described above are formed, during the pattern transferring process, the coating film 31 at the parts where the convexes 23 are pressed in move smoothly toward the concaves 24 in the concave/convex pattern 25. Accordingly, as described above, it is possible to press the convexes 23 sufficiently deeply into the coating film 31. As a result, unlike the case where a stamper constructed in the same way as a stamper for molding an optical disc substrate is used (a stamper constructed so that the gaps S described above are not formed), it is possible to avoid a situation where thick residue is produced between the end surfaces of the convexes 23 in the concave/convex pattern 25 and the surface of the magnetic layer 12.

In addition, with the manufacturing apparatus 50 described above, from the point when the press device 53 starts to press the stamper 2 onto the coating film 31 until the stamper 2 is completely separated, the preform 10 (the coating film 31) and the stamper 2 are both kept at a similar temperature to room temperature without carry out a heating process and a cooling process on both the preform 10 (the coating film 31) and the stamper 2. When a large difference in temperature is produced between the preform 10 (the coating film 31) and the stamper 2 from the start of the pressing operation until the stamper 2 is completely separated (i.e., when a heating process or a cooling process has been carried out), the surfaces of the preform 10 and the stamper 2 will become relatively displaced due to the difference between the coefficient of thermal expansion of the preform 10 and the coefficient of thermal expansion of the stamper 2. As a result, there is the risk of faults being produced in the concave/convex pattern 35 transferred to the coating film 31. Accordingly, with the manufacturing apparatus 50, by keeping both the preform 10 (the coating film 31) and the stamper 2 at a similar temperature to room temperature without carrying out a heating process or a cooling process on either the preform 10 (the coating film 31) or the stamper 2 until the stamper 2 has been completely separated, it is possible to avoid producing faults in the concave/convex pattern 35. Note that the expression “room temperature” in the present specification refers to a temperature in a range of 20° C. to 30° C., inclusive.

Next, the relationship between the irradiated amount of the UV rays 52a and the form of the concave/convex pattern 35 and the relationship between the time from the stopping of irradiation with the UV rays 52a until the stamper 2 is pressed on and the form of the concave/convex pattern 35 will be described with reference to the drawings.

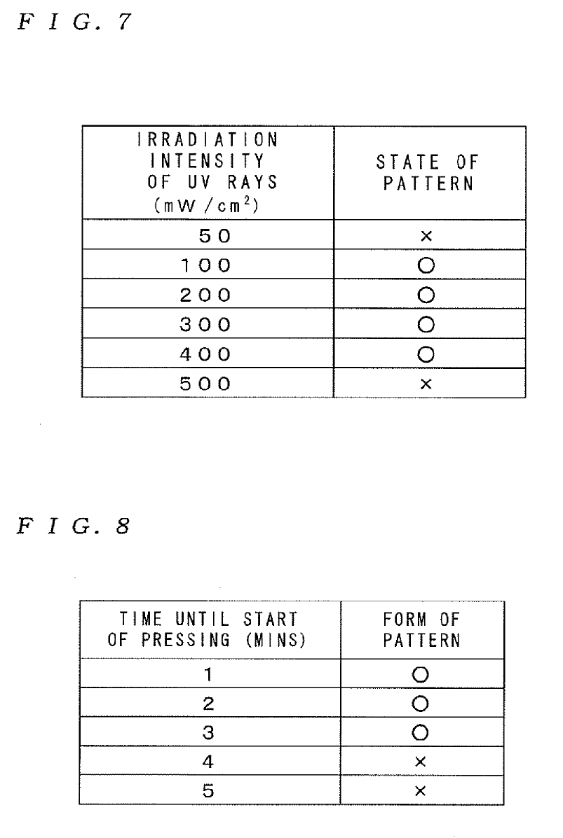

First, in the sane way as in the method of manufacturing the mask 30 described above, a coating composition (an epoxy resin material where a hardening reaction proceeds due to cationic polymerization) was applied onto six preforms 10 by the coating device 51 to form the coating films 31. Next, the coating films 31 were irradiated by the UV ray irradiating device 52 with the UV rays 52a for one second. When doing so, the irradiation intensities of the UV rays 52a used to irradiate the coating films 31 of the preforms 10 were set at 50 mW/cm², 100 mW/cm², 200 mW/cm², 300 mW/cm², 400 mW/cm² and 500 mW/cm², respectively. Next, one minute after irradiation with the UV rays 52a by the UV ray irradiating device 52 had stopped, the stamper 2 was pressed by the press device 53 onto the coating films 31, the pressed state was maintained for three minutes, and then the stamper 2 was separated from the coating films 31. The concave/convex patterns transferred to the coating films 31 were observed using an AFM (Atomic Force Microscope). In FIG. 7, coating films 31 where the concave/convex pattern was favorably transferred across the entire preform 10 are indicated by circles and coating films 31 where the concave/convex pattern was not favorably transferred are indicated by crosses.

As shown in FIG. 7, for the example where the coating film 31 was irradiated for one second with the UV rays 52a with an intensity of 50 mW/cm², although the hardening reaction commenced due to the irradiation with the UV rays 52a, the coating composition was not sufficiently hardened before the stamper 2 was separated (at a point tour minutes after irradiation with the UV rays 52a stopped), resulting in the coating composition adhering to part of the concave/convex pattern 25 of the separated stamper 2. For this reason, part of the coating film 31 was separated from the preform 10 and therefore the mask 30 could not be formed favorably on the preform 10. On the other hand, for the example where the coating film 31 was irradiated for one second with the UV rays 52a with an intensity of 500 mW/cm², the hardening reaction commenced due to the irradiation with the UV rays 52a but the hardening reaction of the coating composition proceeded excessively before the stamper 2 was pressed onto the coating film 31 (at a point one minute after irradiation with the UV rays 52a stopped). Accordingly, the convexes 23 of the stamper 2 could not be sufficiently pressed into the coating film 31, resulting in an inability to form the mask 30 favorably on the preform 10.

On the other hand, for the examples where the coating film 31 was irradiated with the UV rays 52a with respective intensities of 100 mW/cm², 200 mW/cm², 300 mW/cm², and 400 mW/cm², the convexes 23 of the stamper 2 could be pressed into the coating film 31 sufficiently deeply and the coating composition could be sufficiently hardened by the time the stamper 2 was separated (at a point four minutes after irradiation with the UV rays 52a stopped), and therefore the state of the coating film 31 on which the concave/convex pattern 25 had been transferred (i.e., the state where the concave/convex pattern 35 was formed in the coating film 31) could be maintained without the coating film 31 being separated from the preform 10 together with the stamper 2. As a result, it was possible to favorably form the mask 30 on the preform 10. In this way, the applicant confirmed that it is necessary to adjust the amount of radiation (in this example, the UV rays 52a) used to irradiate the coating film in accordance with the hardening reaction characteristics of the resin material applied as the coating composition so that the hardening reaction sufficiently proceeds even after the irradiation has stopped and so that the hardening reaction does not proceed excessively before the stamper 2 is pressed onto the coating film.

Next, a coating composition (an epoxy resin material where a hardening reaction proceeds due to cationic polymerization) was applied onto five preforms 10 by the coating device 51 in the same way as the method of forming the mask 30 described above to form coating films 31 on the preforms 10. Next, the coating films 31 were irradiated by the UV ray irradiating device 52 for one second with the UV rays 52a with an intensity of 300 mW/cm². After this, after a predetermined time passed following the stopping of irradiation with the UV rays 52a by the UV ray irradiating device 52, the stamper 2 was pressed by the press device 53 onto the coating films 31. When doing so, the time from the stopping of irradiation with the UV rays 52a by the UV ray irradiating device 52 to the pressing of the stamper 2 onto the coating films 31 was set at one minute, two minutes, three minutes, four minutes, and five minutes for the respective coating films 31. Next, the stamper 2 was pressed onto the coating films 31 and held for three minutes and then the stamper 2 was separated from the coating films 31. The concave/convex patterns transferred to the coating films 31 were observed using an AFM (Atomic Force Microscope). In FIG. 8, coating films 31 where the concave/convex pattern was favorably transferred across the entire preform 10 are indicated by circles and coating films 31 where the concave/convex pattern was not favorably transferred are indicated by crosses.

As shown in FIG. 8, for the examples where the stamper 2 was pressed onto the coating films 31 three minutes or less after the stopping of irradiation with the UV rays 52a, the convexes 23 of the stamper 2 could be pressed sufficiently deeply into the coating films 31, and therefore the concave/convex pattern 25 could be properly transferred across the entire preforms 10. Accordingly, it was possible to favorably form the mask 30 on the preforms 10. On the other hand, for the examples where the stamper 2 was pressed onto the coating films 31 four minutes or more after the stopping of irradiation with the UV rays 52a, it was not possible to press the convexes 23 of the stamper 2 sufficiently deeply into the coating films 31, and therefore it was not possible to favorably transfer the concave/convex pattern 25 onto the coating films 31. Accordingly the mask 30 could not be formed on the preform 10. In this way, the applicant confirmed that it is necessary to press the stamper 2 onto the coating film 31 in accordance with the hardening reaction characteristics of the resin material applied as the coating composition so that the stamper 2 is pressed on before the hardening reaction has proceeded excessively.

Here, when the stamper 2 has been pressed on the coating film 31 in a state where the hardening of the coating film 31 has proceeded excessively, thick residue is produced on the preform 10 due to the convexes 23 of the stamper 2 being insufficiently pressed in. For this reason, to avoid having thick residue produced and thereby reduce the time taken by the removing process for the residue, as one example it is necessary to carry out a heating process that heats the coating film 31 to the glass transition point so that the convexes 23 can be pressed in easily. However, if a heating process is carried out on the coating film 31, it becomes necessary to lower the temperature of the preform 10 (the coating film 31) to room temperature (i.e., to carry out a cooling process) after the pattern transferring process has been completed. This means it becomes necessary to provide a space to leave the preform 10 during the cooling process and since the time required to manufacture the information recording medium 1 is increased by the time required by the cooling process, there is the risk of an increase in the manufacturing cost of the information recording medium 1. Accordingly, the irradiated amount of radiation for the coating film 31 and the time from the stopping of irradiation to the pressing-on of the stamper 2 should preferably be adjusted, and by making such adjustments, a heating process can be omitted and the manufacturing time can be sufficiently reduced.

In this way, according to the mask forming method carried out by the information recording medium manufacturing apparatus 50, by forming the concave/convex pattern 35 that corresponds to the “concave/convex pattern of the mask” for the present invention by carrying out a coating film forming process that forms the coating film 31 on the preform 10, a UV-ray irradiating process (a radiation irradiating process) that irradiates the coating film 31 with the UV rays 52a, and the pattern transferring process that transfers the concave/convex pattern 25 of the stamper 2 onto the coating film 31 in the mentioned order, unlike the conventional mask forming method that forms a mask by hardening an organic resin layer by irradiation with light transmitted through a stamper, it is possible to form the mask 30 without using a stamper formed of a light-transmitting material. Since it is possible to manufacture the stamper 2 using a variety of materials selected in view of their durability, for example, it becomes possible to repeatedly use the stamper 2, and as a result the cost of forming the mask 30 can be sufficiently reduced. Also, unlike when the stamper is formed of glass, For example, it is possible to easily fabricate a plurality of metal stampers 2 from a single stamper manufacturing matrix, and therefore the manufacturing cost of the stamper 2 can be sufficiently reduced. Accordingly, by using the information recording medium manufacturing method that manufactures the information recording medium 1 using the mask 30 formed according to the mask forming method described above (in the above example, the information recording medium manufacturing method that forms the information recording medium 1 by forming the concave/convex pattern 15 on the preform 10 using the mask 30), it is possible to sufficiently reduce the manufacturing cost of the information recording medium 1.

With the mask forming method that uses the information recording medium manufacturing apparatus 50 described above, a resin material where the hardening reaction proceeds even after irradiation with the UV rays 52a has stopped is applied as the coating composition. As a specific example, a resin material where the hardening reaction proceeds due to cationic polymerization is applied as the resin material described above. Accordingly, with the mask forming method that uses the information recording medium manufacturing apparatus 50 described above, if the coating film 31 is irradiated with the UV rays 52a before the pattern transferring process for the present invention, the hardening reaction of the coating film 31 will gradually proceed from the commencement of irradiation with the UV rays 52a and the coating film 31 will gradually harden even during the pattern transferring process (i.e., while the stamper 2 being pressed onto the coating film 31). As a result, a situation where the pattern loses its shape when the pattern transferring process is completed (i.e., when the stamper 2 is separated from the coating film 31) is avoided, and the concave/convex pattern 25 can be properly transferred across the entire preform 10. Also, by suitably adjusting the irradiated amount of the UV rays 52a on the coating film 31 (i.e., the irradiation intensity and the irradiating time of the UV rays 52a), it is possible to sufficiently harden the coating film 31 without irradiating the UV rays 52a after the pattern transferring process has been completed (i.e., after the stamper 2 has been separated from the coating film 31). Accordingly, compared to a pattern forming method where the coating film 31 is irradiated with the UV rays 52a before and after the pattern transferring process, the time required to form the mask 30 can be sufficiently reduced and therefore the forming cost can be sufficiently reduced.

Note that the present invention is not limited to the construction and method described above. For example, although an example where an epoxy resin material where a hardening reaction proceeds due to cationic polymerization is used as the coating composition for the present invention has been described, it is possible to form the mask 30 on the preform 10 using various types of resin materials where a hardening reaction occurs only while the material is being irradiated with the UV rays 52a. More specifically, in place of the resin material used to form the mask 30 described above, it is possible to form the coating film 31 by applying a resin material where a hardening reaction proceeds due to radical polymerization (one example of a resin material where a hardening reaction occurs only during irradiation with radiation) onto the preform 10 and to partially harden the coating film 31 by irradiation with radiation (for example, the UV rays 52a). When doing so, the convexes 23 of the stamper 2 can be pressed in sufficiently deeply, and the coating film 31 can be hardened to a sufficient extent where the transferred concave/convex pattern does not lose its shape when the stamper 2 is separated. Next, the concave/convex pattern 25 of the stamper 2 is pressed onto the partially hardened coating film 31, and after this state has been maintained for a predetermined time, the stamper 2 is separated from the coating film 31. By doing so, the concave/convex pattern 35 is formed in the coating film 31 on the preform 10. After this, the coating film 31 in which the concave/convex pattern 35 has been formed is irradiated again with the UV rays 52a so that the coating film 31 is sufficiently hardened. In this way, even if a resin material where the hardening reaction proceeds only while the material is being irradiated with the UV rays 52a is used, it will still be possible to form the mask 30 without the coating film 31 on the preform 10 being irradiated with the UV rays 52a while the stamper 2 is pressed onto the coating film 31. Accordingly, in the same way as with the forming method of the mask 30 that uses the manufacturing apparatus 50 described above, it is possible to form the mask 30 using a low-cost stamper 2 formed of a material that does not transmit light.

Aside from radiation-curing resin materials, it is possible to add a variety of resin materials as the “resin” for the present invention. More specifically, it is also possible to use a method where a small amount of a thermosetting resin material is added to the radiation hardening resin material and a heating process is carried out on the preform 10 (the coating film 31) after the stamper 2 has been separated to sufficiently harden the coating film 31. The “radiation” for the present invention is not limited to the UV rays 52a and it is possible to harden the coating film 31 by irradiation with various types of radiation such as an electron beam and X rays in accordance with the coating composition that forms the coating film 31. Also, although an example where the coating film 31 has been formed on the magnetic layer 12 has been described, the present invention is not limited to this. For example, another mask forming layer may be formed on the magnetic layer 12, with the coating film 31 being formed on such a mask forming layer. In this case, after the concave/convex pattern (mask pattern) has been formed on the mask forming layer using the concave/convex pattern 35 (i.e., the mask 30) transferred to the coating film 31 by pressing in the stamper 2, an etching process is carried out on the magnetic layer 12 using the mask forming layer as a mask.

In addition, although a method of forming the mask 30 for carrying out a dry etching process on the magnetic layer 12 has been described, the mask formed by the mask forming method for the present invention is not limited to a mask used by a dry etching process and can be a mask used by a wet etching process. Here, the wet etching process corresponds to another example of a process for “forming a concave/convex pattern on a substrate” for the present invention. The mask formed by the mask forming method according to the present invention is not limited to a mask used by an etching process. For example, the term “mask” for the present invention includes a mask used in a process (a so-called “lift-off process”) that forms a concave/convex pattern on a substrate by forming a thin film on the convexes in a concave/convex pattern (a concave/convex pattern after residue on the concave base surfaces has been removed) of a mask formed over a substrate and also on the substrate exposed from the mask at the base surfaces of the concaves in the concave/convex pattern of the mask and then removes the mask from the substrate to remove the thin film formed on the convexes in the mask from the substrate together with the mask and leave the thin film formed on the base surfaces of the concaves in the mask (i.e., the thin film formed on the substrate) (the remaining thin film corresponds to convexes in the concave/convex pattern formed on the substrate). For a mask used in a lift-off process, a concave/convex pattern where the residue on the concave base surfaces has been removed following the pattern transferring process for the present invention corresponds to the “mask” for the present invention. Also, the lift-off process corresponds to yet another example of the process of “forming a concave/convex pattern on a substrate” for the present invention.

The mask formed according to the mask forming method of the present invention is not limited to being used to manufacture an information recording medium, and as one example can also be applied to a mask used when manufacturing a semiconductor element or the like. By doing so, the manufacturing cost of a semiconductor element or the like can be sufficiently reduced. The information recording medium manufactured using a mask formed using the mask forming method according to the present invention is not limited to a discrete-track type magnetic disk like the information recording medium 1 described above, and includes a magnetic disk where data track patterns are magnetically written onto a continuous magnetic layer and servo patterns are formed by concave/convex patterns. In addition, the information recording medium is not limited to a magnetic disk like the information recording medium 1 that uses a perpendicular recording method, and also includes a magnetic disk recorded by a longitudinal recording method. Also, the mask forming method according to the present invention can also be favorably applied when manufacturing an optical disc (or an optical recording medium), not only when manufacturing a magnetic disk.

What is claimed is:

1. A mask forming method that forms a concave/convex pattern in a mask formed over a substrate, the mask forming method comprising:
a coating film forming process that forms a coating film by applying a radiation-curing coating composition onto the substrate;
a radiation irradiating process that irradiates the coating film with radiation; and
a pattern transferring process that presses a surface of a stamper on which a concave/convex pattern has been formed onto the coating film to transfer the concave/convex pattern to the coating film,
Wherein the coating film forming process, the radiation irradiating process, and the pattern transferring process are carried out in the mentioned order.

2. A mask forming method according to claim 1, wherein a resin material where a hardening reaction proceeds even after irradiation with the radiation has stopped is applied as the coating composition.

3. A mask forming method according to claim 2, wherein a resin material where the hardening reaction proceeds due to cationic polymerization is applied as the resin material.

4. An information recording medium manufacturing method that manufactures an information recording medium using a mask formed using a mask forming method according to claim 1.
